(19) United States
(12) Patent Application Publication
(10) Pub. No.: US 2025/0342780 A1
(43) Pub. Date: Nov. 6, 2025

(54) SYSTEMS AND METHODS FOR IDENTIFYING A CRYOGENIC SAMPLE

(71) Applicant: Instant Systems, Inc., Norfolk, VA (US)

(72) Inventors: Mahir DAGRA, Norfolk, VA (US); Emilio A. EDWARDS, Norfolk, VA (US); Uzair A. RAJPUT, Virginia Beach, VA (US)

(73) Assignee: Instant Systems, Inc., Norfolk, VA (US)

(21) Appl. No.: 19/198,669

(22) Filed: May 5, 2025

Related U.S. Application Data
(60) Provisional application No. 63/643,007, filed on May 6, 2024.

(51) Int. Cl. G09F 3/04; A01N 1/142; G09F 3/02

(52) U.S. Cl. CPC G09F 3/04; A01N 1/142; G09F 3/02; G09F 2003/0222

(57) ABSTRACT

Systems and methods are provided for identifying a cryogenic sample. An identification tag for cryogenic storage includes an identification portion, a retention portion, and the tether portion. The identification portion defines a retention opening a label opening that is sized to receive a label. The retention portion is sized to be received by the retention opening and at least partially occlude the label opening. The tether portion extends between the identification portion and the retention portion. The tether portion is threaded through a portion of a cryogenic storage container and the retention portion is received by the retention opening to couple the identification tag to the cryogenic storage container.

### CROSS-REFERENCE TO RELATED APPLICATIONS

This application claims priority to and the filing date benefit of U.S. Provisional Patent Application No. 63/643,007, filed May 6, 2024, entitled “Systems and Methods for Identifying a Cryogenic Sample,” which is incorporated herein by reference in its entirety.

### BACKGROUND

The embodiments described herein relate to the storing of materials in a cryogenic environment. More particularly, the embodiments described herein relate to systems and methods for identifying a cryogenic sample.

Cryogenic storage is a known technique that is used to preserve certain samples, such as biological materials, by cooling the sample to a low temperature. Typically, cryopreservation is achieved via cryogenic storage by storing the cryogenic sample at 130° C. or less. At such cryogenic temperatures, enzymatic and/or chemical activities affecting the cryogenic sample are effectively halted thereby limiting or precluding damage to the cryogenic sample that could otherwise occur if the sample were stored at a higher temperature. For example, cryopreservation can be used to effectively preserve samples like stem cells, tissue samples, blood components, and DNA. To use the cryogenic sample, such as for a therapeutic treatment, testing, or for other similar purposes, the cryogenic sample is typically thawed.

In some known cryopreservation processes, the freezing, storing, and thawing of the cryogenic sample are accomplished with the cryogenic sample remaining in a single container throughout. For example, the cryogenic sample is often placed and sealed in a flexible storage container, such as a cryopreservation bag, a cryogenic freezing bag, a cryogenic storage bag, or a cryobag, prior to freezing. The cryogenic storage bag containing the cryogenic sample is then cooled and cryopreserved in liquid nitrogen.

In addition to preserving the cryogenic sample, it is also essential to preserve the identification of the cryogenic sample. The identification can ensure that crucial information, such as specimen type, collection date, batch number, specimen identifiers, and/or tracing information remains associated with the cryogenic sample from preparation through the use. Accordingly, it is desirable that the identification of the cryogenic sample remain coupled directly to the cryogenic storage bag thereby ensuring that one identification does not become inadvertently associated with a different sample. In fact, maintaining proper identification of cryogenic samples can be subject to strict regulatory standards, especially in clinical and biomedical research settings. To that end, known cryogenic labels have been developed to adhere to tubes and files for cryogenic storage. Such cryogenic labels include an adhesive that retains its adhesion at cryogenic temperatures.

Often, the cryogenic storage bag is formed from ethylene-vinyl acetate (EVA). However, EVA is known to lose flexibility and become more brittle at cryogenic temperatures. This property of EDA increases the likelihood that the cryogenic storage bag can be damaged (e.g., torn or ruptured) during handling, such as during removal from the liquid nitrogen for thawing. A known alternative to the use of EVA is to form the cryogenic storage bag from fluorinated ethylene propylene (FEP). FEP is known to remain flexible at cryogenic temperatures, thereby, reducing the likelihood of damage during handling. However, one of the properties of FEP is that FEP resists adhesion. In other words, adhesive labels that identify the cryogenic sample cannot be reliably adhered to a cryogenic storage bag formed from FEP.

Thus, a need exists for improved systems and methods for identifying a cryogenic sample.

### SUMMARY

In some embodiments, the present disclosure is directed to an identification tag for cryogenic storage. The identification tag includes an identification portion that defines a retention opening and a label opening. The label opening is sized to receive a label on a condition that the identification tag is in a first configuration. A retention portion is sized to be received by the retention opening to at least partially occlude the label opening on a condition that the identification tag is in a second configuration in which the label is received by the identification portion and the identification is tag is coupled to a cryogenic storage container. A tether portion extends between the identification portion and the retention portion. The tether portion defines a longitudinal axis of the identification tag in the first configuration.

In some embodiments, the tether portion extends along the longitudinal axis between the identification portion at a first longitudinal position along the longitudinal axis and the retention portion at a second longitudinal position on the condition that the identification tag is in the first configuration.

In some embodiments, the retention portion is positioned at the first longitudinal position on the condition that the identification tag is in the second configuration.

In some embodiments, the identification portion, the tether portion and the retention portion are formed from a first layer coupled to a separate second layer via at least one sealed region. An area of the sealed region is in a range of 2 to 15 percent of an area of the first layer.

In some embodiments, the first layer has a first stiffness at a cryogenic temperature. The second layer has a second stiffness at the cryogenic temperature. The sealed region has a third stiffness at the cryogenic temperature. The third stiffness is greater than the first stiffness, the second stiffness, and a combination of the first stiffness and the second stiffness.

In some embodiments, the sealed region in the tether portion is a first sealed region that is separated laterally from the longitudinal axis in a first direction and extends in a longitudinal direction. The tether portion includes a second sealed region that is separated laterally from the longitudinal axis in a second direction opposite the first direction and extends in the longitudinal direction. The first sealed region is separated from the second sealed region by an unsealed region in which the first layer is not joined to the second layer.

In some embodiments, the first layer is movable relative to the second layer along the unsealed region. The movement of the first layer relative to second layer along the unsealed region facilitates a stiffness of the tether portion along the unsealed region that is less than a stiffness of each of the first sealed region and the second sealed region.

In some embodiments, the tether portion is flexible at cryogenic temperatures.

In some embodiments, the unsealed region has a lateral width that is in the range of 20 to 50 percent of a width of the tether portion.

In some embodiments, the first layer and the second layer are shaped to form a barb of the retention portion. The sealed region extends partially within the barb. The unsealed region is a first unsealed region. A second unsealed region in which the first layer is not joined to the second layer is formed at a tip of the barb. The second unsealed region is separated from the first unsealed region by the sealed region.

In some embodiments, the identification portion includes a third layer coupled to the first layer opposite the second layer. A separation between the third layer and the first layer defining the label opening. Each of the first layer, the second layer, and the third layer define the retention opening such that the retention opening extends completely through a thickness of the identification portion. The barb has an expanded configuration on the condition that the identification tag is in the first configuration and on the condition that condition that the identification tag is in the second configuration. The barb is precluded from passing through the retention opening in the expanded configuration. The barb has a collapsed configuration during a transition of the identification tag from the first configuration to the second configuration. The collapsed configuration facilitates passage of the retention portion through the retention opening.

In some embodiments, the label opening is positioned at a longitudinal position between the retention opening and the tether portion.

In some embodiments, the retention opening extends between a pair of stress-distribution holes. A width of the tether portion is substantially equal to a lateral distance between a center point of each of the stress-distribution holes.

In some embodiments, the retention opening is a nonlinear opening.

In some embodiments, the retention portion includes a protrusion that extends radially outward from the longitudinal axis to a lateral position that is in a range of 0.9 to 1.5 times the width of the tether portion. The protrusion is deformable between an expanded configuration and a collapsed configuration. The protrusion is in the expanded configuration on the condition that the identification tag is in the first configuration and on the condition that the identification tag is in the second configuration. The protrusion is in the collapsed configuration during a transition of the identification tag from the first configuration to the second configuration.

In some embodiments, the retention portion includes a set of barbs formed by a first layer and a separate second layer. Each barb of the set of barbs has a span between a base and a tip. The base of each barb of the set of barbs is positioned laterally between the tip and the longitudinal axis. The first layer and the second layer are sealed from the base in the direction of the tip along between 30 and 75 percent of the span of each barb of the set of barbs and have an absence of sealing along a remainder of the span to the tip.

In some embodiments, each barb of the set of barbs has a leading edge that extends between the base and tip. The leading edge intersects the longitudinal axis at a first acute angle. Each barb of the set of barbs has a trailing edge that extends between the base and tip. The trailing edge intersects the longitudinal axis at a second acute angle that is greater than the first acute angle. The trailing edge is positioned between the leading edge and the label opening on the condition that the identification tag is in the first configuration. The trailing edge of at least one barb is positioned to contact the identification portion on the condition that the identification tag is in the second configuration to preclude a transition of the identification tag from the second configuration to the first configuration.

In some embodiments, the tether portion is coupled to the identification portion via a transition portion. The transition portion includes a pair of concave radii bisected by the longitudinal axis. The concave radii are sized to mitigate a stress concentration resulting from a greater width of the identification portion relative to a width of the tether portion.

In some embodiments, the cryogenic storage container is a cryogenic storage bag configured to store biological material. The tether portion is threaded through a portion of the cryogenic storage bag on the condition that the identification tag is in the second configuration.

In some embodiments, the cryogenic storage bag and the identification tag are each formed from fluorinated ethylene propylene and are flexible at a cryogenic temperature.

In some embodiments, the present disclosure is directed to a biological material storage system. The biological material storage system includes a sample container that includes a first flexible layer coupled to a second flexible layer via a set of seals to define a storage volume. The first flexible layer and the second flexible layer are flexible at a cryogenic temperature. The biological material storage system also includes a cryogenic cassette sized to receive the sample container. The cryogenic cassette includes a body portion and a cover. At least one of the body portion or the cover define an observation aperture. The sample container is in fluid contact with an environment surrounding the cryogenic cassette on a condition that the sample container is positioned within the cryogenic cassette. An identification tag is movably coupled to the sample container via a tether portion of the identification tag. The identification tag is positioned within the cryogenic cassette on the condition that the sample container is positioned within the cryogenic cassette. An identification portion of the identification tag. Aligned with the observation aperture on the condition that the sample container is positioned within the cryogenic cassette.

In some embodiments, the first flexible layer, the second flexible layer, and the identification tag are each formed from fluorinated ethylene propylene and are flexible at the cryogenic temperature.

In some embodiments, the identification portion of the identification tag defines a retention opening and a label opening. The label opening is sized to receive a label prior to the identification tag being movably coupled to the sample container. The identification tag includes a retention portion is received by the retention opening to at least partially occlude the label opening and movably couple the identification tag to the sample container. The tether portion extends between the identification portion and the retention portion. The tether portion defines a longitudinal axis of the identification tag prior to the identification tag being movably coupled to the sample container.

### BRIEF DESCRIPTION OF THE DRAWINGS

FIG. 1 is a top view of an identification tag in a first configuration according to an embodiment.

FIG. 2 is a schematic view of the identification tag of FIG. 1.

FIG. 3 is a top view of the identification tag of FIG. 1 in a second configuration.

FIG. 4 is a side view of the identification tag of FIG. 1 in the second configuration.

FIG. 5 is a cross-sectional view of the identification tag of FIG. 1 taken at x₁-x₁.

FIG. 6 is a close-up top view of a retention portion of the identification tag of FIG. 1 according to an embodiment.

FIG. 7 is a close-up top view of a portion of the retention portion of FIG. 6 with barbs in a collapsed configuration according to an embodiment.

FIG. 8 is a close-up top view of a retention opening of the identification tag of FIG. 1 according to an embodiment.

FIG. 9 is a perspective view of the identification tag of FIG. 1 depicting a retention portion being received by a retention opening.

FIG. 10 is a perspective view of a retention portion partially received by a retention opening.

FIG. 11 is a side view of a pair of barbs of a retention portion in an expanded configuration following a passage through the retention opening according to an embodiment.

FIG. 12 is a close-up top view depicting a first pair of barbs following passage through the retention portion a second pair of barbs prior to passage through the retention portion.

FIG. 13 is a close-up top view of the retention portion following passage through the retention opening.

FIG. 14 is a schematic view of a biological material storage system according to an embodiment.

FIG. 15 is a schematic view of the biological material storage system of FIG. 14 depicting a sample container positioned within a cryogenic cassette.

### DETAILED DESCRIPTION

Generally, the present disclosure is directed to systems and methods for identifying a cryogenic sample. More particularly, an identification tag is described herein which can be coupled to a cryogenic storage bag to ensure that crucial information, such as specimen type, collection date, batch number, specimen identifiers, and/or tracing information remains associated with the cryogenic sample from preparation, through freezing, storage, and eventual use. To accomplish this goal, the identification tag receives and securely holds a label that contains the crucial information. The identification is formed to remain flexible at cryogenic temperatures while also retaining sufficient strength to preclude separation (e.g., from tearing or the failure of retention features) from the storage bag during sample handling or storage.

As used herein, the term “biological (or biologic) material” refers to any material that is produced or derived from a living (or recently living) organism. Biological materials can include, for example, tissue specimens, tissue grafts, cells, blood, or other bodily fluids. Biological materials can also include plants, plant products, micoorganisms, genetically modified organisms (including cells and cell lines). Biological materials can also include DNA or RNA (including plasmids, oligonucleotides, cDNA) or viral vectors. Biological materials can also include material that is produced by a living (or recently living) organism, such as small or large molecule pharmaceuticals.

Other examples of biological materials include (but are not limited to) human and animal cells or cellular materials, plant materials (tissue and cellular materials), organs, organoids, biologically sourced materials (e.g., printed tissues, cells, organs, or organoids), bacteria, viruses, viral vectors, fungi, medical devices, combination devices, material for homologous or non-homologous use, and/or materials for autologous or allogenic use. In some embodiments, a biological material can include cellular material, including but is not limited to, lineage committed and non-lineage committed cells (e.g., bone lineage committed cells, osteoblasts, osteocytes, etc.), differentiated cells or non-differentiated cells (e.g., muscle cells, endothelial cells, etc.), and/or genetically modified or non-genetically modified materials. Further examples of the human or animal cellular materials include, but is not limited to, B-cells, blood cells and blood derived cells, bone cells, CAR-T cells, egg cells, engineered T-Cells, fat cells, muscle, cells, natural killer cells, nerve cells, sperm cells, stem cells (modified and un-modified, differentiated and non-differentiated), T-cells, tumor infiltrating lymphocytes (TIL), viral vectors, viruses and bacteria. The human or animal cellular material can be modified or non-modified (such as genetically modified). Examples of the plant materials include, but is not limited to, cellulose, hemicellulose, pectin, fruit, fungi, leaves, mitochondria, plant organelles, pollen, roots, seeds, shoots, and/or stems.

As used herein, the term “tissue specimen” or “tissue graft” refers to any material that can be used in a tissue repair procedure or other therapeutic procedures (e.g., birth tissue used as patch for healing then removed). Thus, a tissue specimen or a tissue graft can include any of a skin graft, bone tissue, fiber tissue (e.g., tendon tissue, ligament tissue, or the like), ocular tissue (e.g., corneal implants), birth tissue (e.g., amnion graft), cardiovascular tissue (e.g., heart valve), tendons or the like including artificially produced tissue. A tissue specimen or a tissue graft can include a portion of tissue harvested from a donor or a structure component that includes both tissue and non-tissue material (e.g., a synthetic matrix that includes tissue therein). For example, a tissue specimen or a tissue graft can include bone tissue that also includes bone cement or other non-tissue components. As another example, a tissue specimen or tissue graft can include bone chips including cortical bone chips, cancellous bone chips, and corticocancellous bone chips, and/or bone chips with viable bone lineage committed cells. Further examples of human and animal tissues include, but is not limited to, birth tissues (e.g., amnion, cord, cord blood, chorion, placenta, etc.), bones and/or products made from bones (e.g., machined allografts, ground particles, etc.), bone sources (e.g., tibia, fibula, humerus, cranial flaps, radius, ulna, pelvic bones, and joints, etc.), brain tissue, cartilages (from all sources in bodies generally from knee joints, shoulders, etc.), fascia lata, heart valves, arteries, veins, nerves, organs (e.g., lungs, hearts, liver, kidneys, etc.), reproduction tissue (e.g., semen and eggs), ribs, soft tissues (e.g., all tendons, Achilles, patellar, etc.), skin, and/or tumors.

As used herein, the term “about” when used in connection with a referenced numeric indication means the referenced numeric indication plus or minus up to 10 percent of that referenced numeric indication. For example, the language “about 50” covers the range of 45 to 55. Similarly, the language “about 5” covers the range of 4.5 to 5.5.

Specific words chosen to describe one or more embodiments and optional elements or features are not intended to limit the invention. For example, spatially relative terms—such as “beneath”, “below”, “lower”, “above”, “upper”, “proximal”, “distal”, and the like—may be used to describe the relationship of one element or feature to another element or feature as illustrated in the figures. These spatially relative terms are intended to encompass different positions (i.e., translational placements) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the term “below” can encompass both positions and orientations of above and below. A device may be otherwise oriented (e.g., rotated 90 degrees or at other orientations) and the spatially relative descriptors used herein interpreted accordingly. Likewise, descriptions of movement along (translation) and around (rotation) various axes includes various spatial device positions and orientations.

Similarly, geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

In addition, the singular forms “a”, “an”, and “the” are intended to include the plural forms as well, unless the context indicates otherwise. The terms “comprises”, “includes”, “has”, and the like specify the presence of stated features, steps, operations, elements, components, etc. but do not preclude the presence or addition of one or more other features, steps, operations, elements, components, or groups.

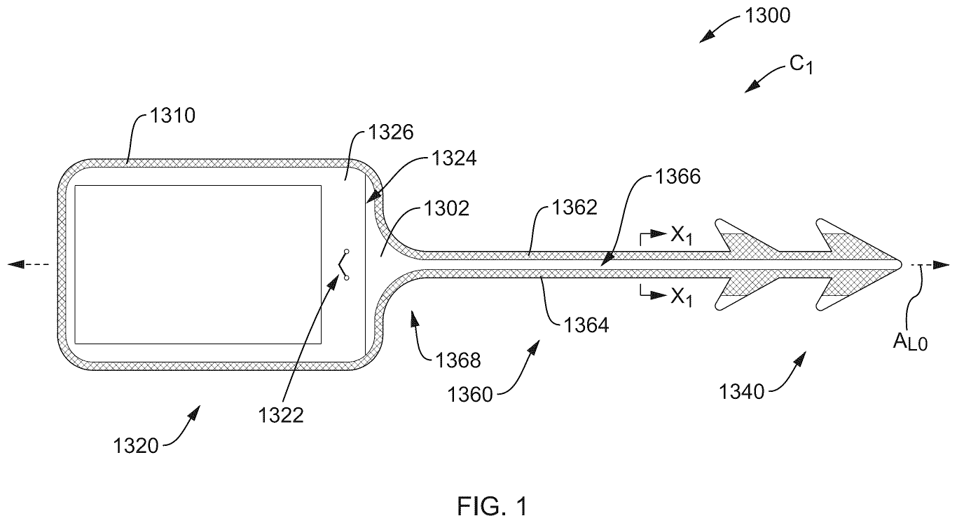

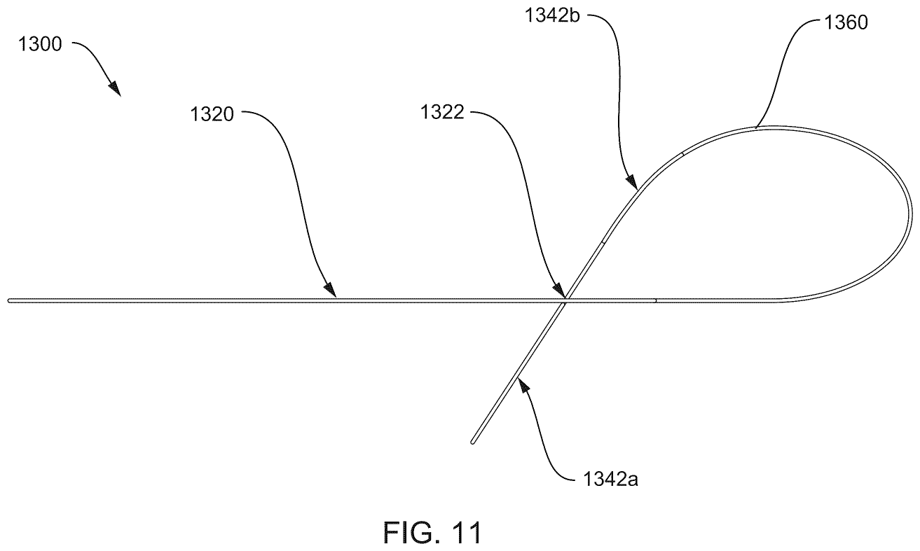

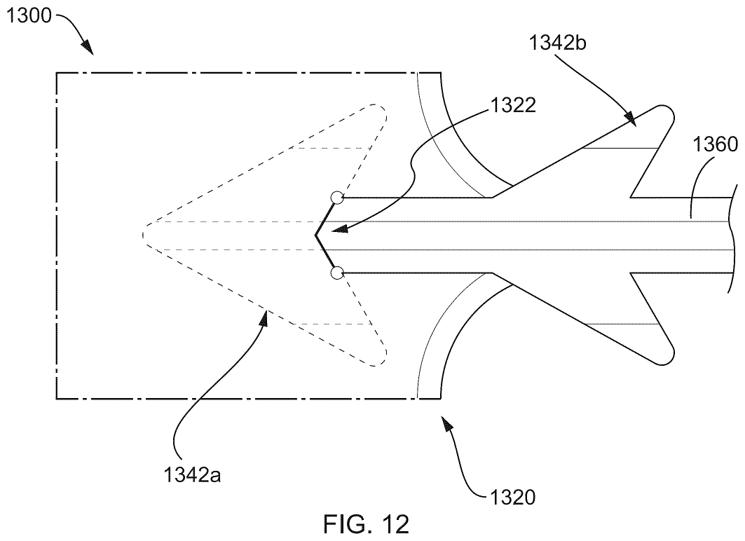

FIGS. 1-13 are views of an identification tag used for the identification of a sample stored at cryogenic temperatures (e.g., cryogenic preservation). As used herein, cryogenic temperatures include temperatures in a range of −20 degrees to −200 degrees Celsius. The sample can, for example, be a biological sample (e.g., blood, blood components, tissue samples, eggs, embryos, semen, ovarian tissue, plant seeds, plant portions, and/or other genetic material) positioned in a cryogenic storage bag, which is then immersed in liquid nitrogen at a temperature of −150 degrees to −196 degrees Celsius. The cryogenic storage bag can be formed from a polymer which remains flexible at cryogenic temperatures. For example, the cryogenic storage bag can be formed from fluorinated ethylene propylene (FEP). The identification tag, as described herein, can be coupled to the cryogenic storage bag to ensure that crucial information, such as specimen type, collection date, batch number, specimen identifiers, and/or tracking information always remains associated with the cryogenic sample.

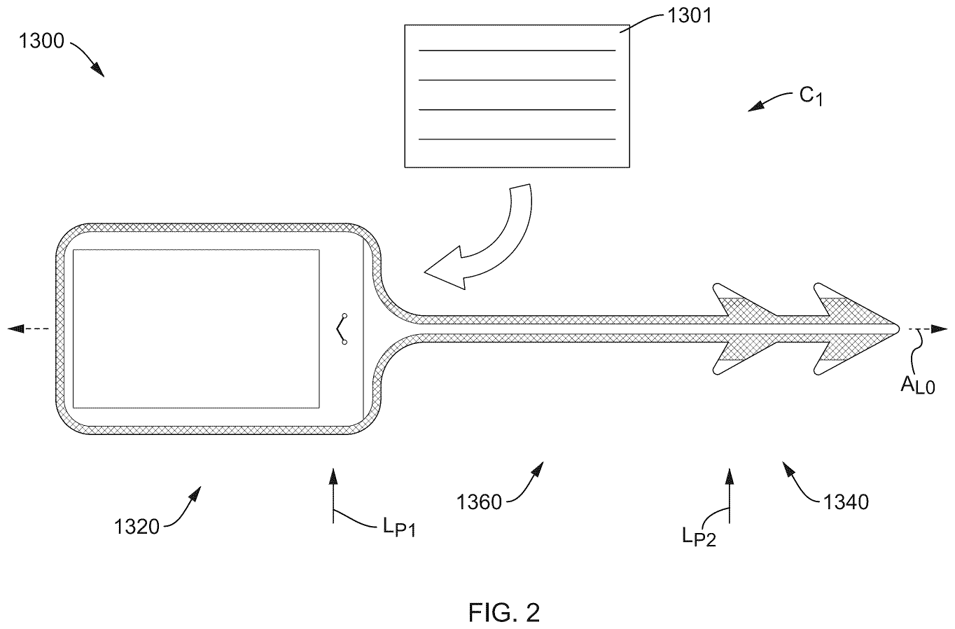

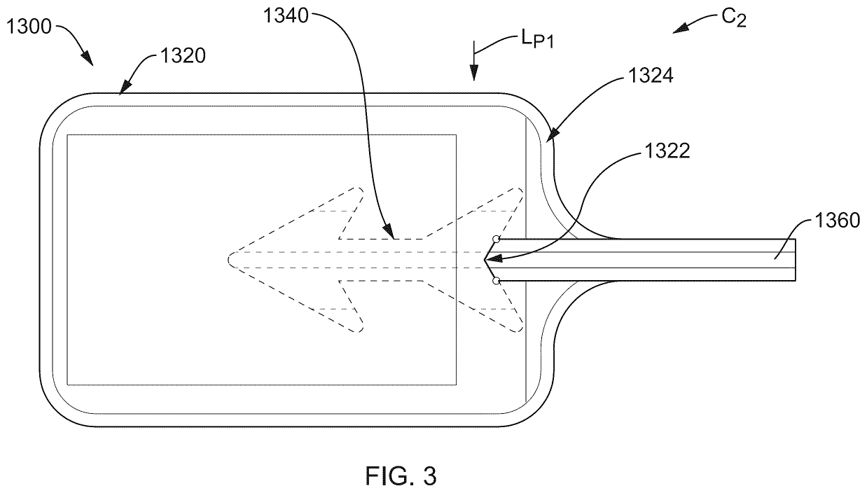

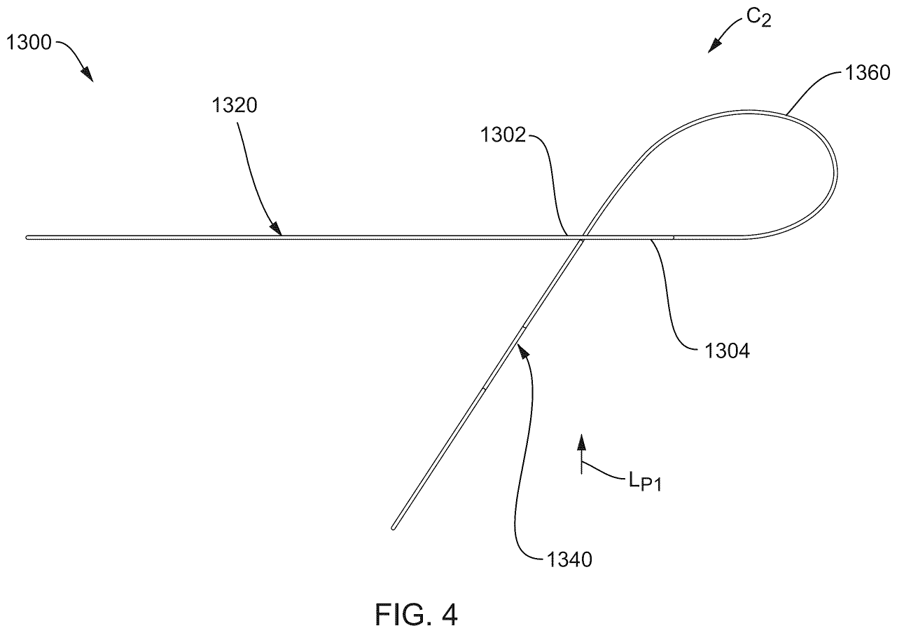

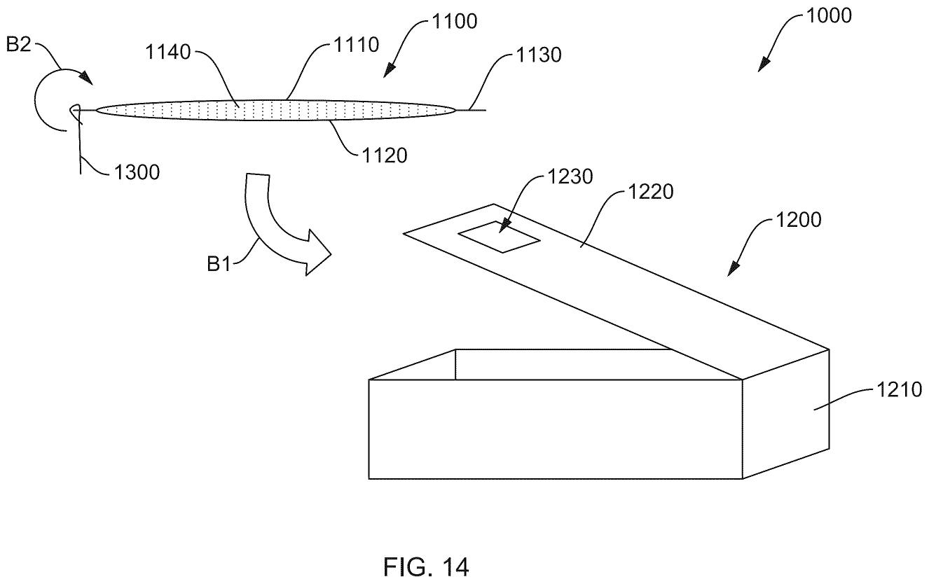

FIGS. 1-4 depict an identification tag 1300 for cryogenic storage. Accordingly, the identification tag 1300 can be a component of a biological material storage system 1000 (FIG. 14) configured for cryogenic preservation. The identification tag 1300 includes an identification portion 1320, a tether portion 1360, and a retention portion 1340. The identification tag 1300 is movable between a first condition C₁ (as depicted in FIGS. 1 and 2) and a second condition C₂ (as depicted in FIGS. 3 and 4). The transition from the first condition C₁ to the second condition C₂ can correspond to the coupling of the identification tag 1300 to a sample container (e.g., the sample container 1100 (FIG. 14) of the biological material storage system 1000).

The identification portion 1320 of the identification tag 1300 defines a retention opening 1322 and a label opening 1324. The label opening 1324 is sized to receive a label 1301 (e.g., a printed cryogenic label) on a condition that the identification tag 1300 is in the first configuration C₁. The label 1301 can include identifying indicia corresponding to the cryogenic sample. The label 1301 can have an absence of an adhesive such that the label is retained by the identification tag 1300 but not adhered to the identification tag 1300 or the sample container 1100.

The retention portion 1340 of the identification tag 1300 is sized to be received by the retention opening 1322. In other words, the retention portion 1340 and the retention opening 1322 are sized so that the retention portion 1340 can be threaded through the retention opening 1322 to at least partially occlude the label opening 1324. By occluding the label opening 1324, the retention portion 1340 can preclude the passage of the label 1301 through the label opening 1324 and away from the identification tag 1300. Therefore, passing the retention portion 1340 through the retention opening 1322 places the identification tag 1300 in the second configuration C₂ in which the label 1301 has been received by the identification portion 1320 and the identification tag 1300 is coupled to a flexible cryogenic storage container (e.g., a cryogenic storage bag as depicted by the sample container 1100).

As depicted in FIGS. 1 and 2, the tether portion 1360 extends between the identification portion 1320 and the retention portion 1340. The tether portion 1360 defines a longitudinal axis A_{LO} of the identification tag 1300 in the first condition C₁. In some embodiments, the tether portion 1360 extends along the longitudinal axis A_{LO} between the identification portion 1320, which is at a first longitudinal position L_{P1}, and the retention portion 1340, which is at a second longitudinal position L_{P2}, on the condition that the identification tag is in the first condition C₁ (such as depicted in FIG. 2).

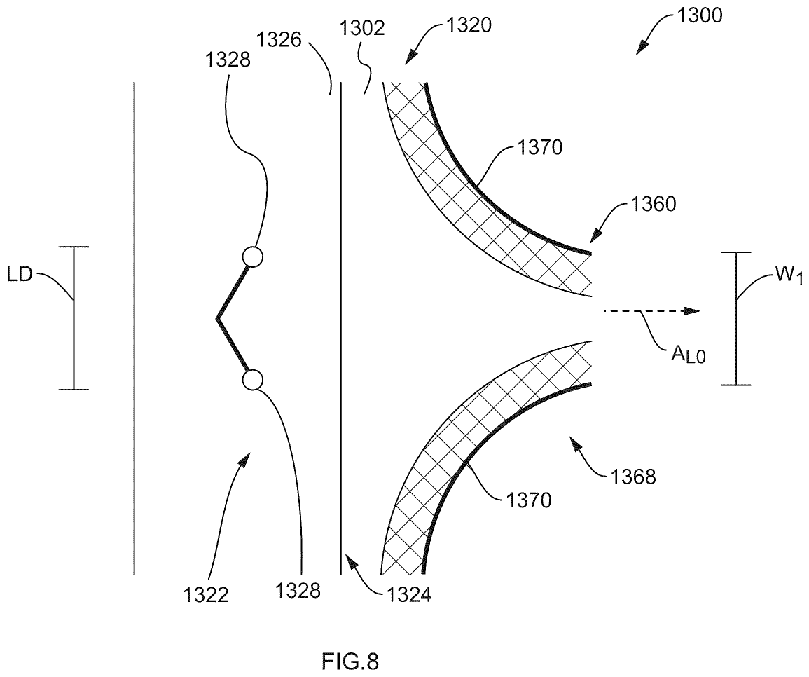

Referring still to FIG. 1, and also to FIG. 8, in some embodiments, the tether portion 1360 is coupled to (e.g., extends from) the identification portion 1320 via a transition portion 1368. The transition portion 1368 includes a pair of concave radii 1370 bisected by the longitudinal axis A_{LO}. The concave radii 1370 are sized to mitigate a stress concentration that would otherwise result from the greater width of the identification portion 1320 relative to that of the tether portion 1360.

The tether portion 1360 has a length along the longitudinal axis A_{LO} that is sized to form a loop, such as depicted in FIG. 4, upon the transition of the identification tag 1300 to the second configuration C₂. Said another way, to transition the identification tag 1300 from the first condition C₁ to the second condition C₂, the retention portion 1340 can be threaded through a receiving portion of the cryogenic storage container and then through the retention opening 1322 to establish the tether portion 1360 in a loop configuration that passes through the receiving portion of the cryogenic storage bag, thereby coupling the identification tag 1300 to the cryogenic storage bag. Said another way, upon the transition of the identification tag 1300 from the first condition C₁ to the second condition C₂, the tether portion 1360 is folded back upon itself along the longitudinal axis. Therefore, in some embodiments, the retention portion 1340 is moved from the second longitudinal position L_{P2} to the first longitudinal position L_{P1} with the transition of the identification tag 1300 to the second configuration C₂, such as depicted in FIG. 4.

In some embodiments, the identification tag 1300 is formed from a first layer 1302 and a second layer 1304 that are joined via at least one sealed region 1310. Said another way, each of the identification portion 1320, the tether portion 1360, and the retention portion 1340 are formed from the first layer 1302 coupled to the second layer 1304 via the at least one sealed region 1310 (e.g., a fused or heat bonded region). FIGS. 1,2 and 6-8 show the sealed regions with a cross-hatching pattern for illustration purposes. The use of the first layer 1302 and the second layer 1304 increases the strength of the identification tag 1300 relative to an identification tag formed from a single layer. In some embodiments, an area of the sealed region 1310 is in a range of 2 to 15 percent (e.g., 3 to 7 percent) of an area (e.g., a surface area) of the first layer 1302. Accordingly, the first layer 1302 has an absence of coupling to the second layer 1304 over 85 to 98 percent of the area of the first layer 1302.

The first layer 1302 and the second layer 1304 can, in some embodiments, be formed from a polymer that is flexible at cryogenic temperatures. For example, the first layer 1302 and/or the second layer 1304 can be can be produced out of any one or more of the following materials: polyethylene (PE), low density polyethylene (LDPE), composites of LDPE, linear low-density polyethylene (LLDPE), high density poly ethylene (HDPE), polychlorotrifluoroethylene (PCTFE), ethylene tetrafluoroethylene (ETFE), polytetrafluoroethylene (PTFE), fluorinated ethylene propylene (FEP), polyurethane, polyimides (coats or non-coated), polyvinyl chloride (PVC), perfluoroalkoxy alkane (PFA), ethylene-vinyl acetate (EVA), polyvinylidene fluoride or polyvinylidene difluoride (PVDF), THV (a polymer of tetrafluoroethylene, hexafluoropropylene and vinylidene fluoride), PFE (Poly (fluorenylene ethynylene)), nylon, and/or composite of nylon. In some embodiments, each of the first layer 1302 and the second layer 1304 are produced out of the same material. In some embodiments, the first layer 1302 and a second layer 1304 are produced out of different materials having a different rigidity at cryogenic temperatures.

The materials of the first layer 1302 are selected such that the first layer 1302 has a first stiffness at a cryogenic temperature. Similarly, the materials of the second layer 1304 are selected such that the second layer 1302 has a second stiffness at the same cryogenic temperature. The sealed region 1310 has a third stiffness at the same cryogenic temperature. The third stiffness is greater than the first stiffness, the second stiffness, and a combination of the first stiffness and the second stiffness. In other words, the sealed region 1310 has a greater rigidity relative to the first layer 1302 and the second layer 1304 at least at the cryogenic temperature. The greater rigidity of the sealed region 1310 facilitates the identification tag 1300 being maintained in a desirable shape. However, minimizing the ratio of the area of the sealed region 1310 to the area of the first layer 1302 minimizes an undesirable degree of rigidity of the identification tag 1300 at the cryogenic temperature. Said another way, the desirable flexibility of the identification tag 1300 at the cryogenic temperature is maximized by minimizing the area of the sealed region 1310 relative to the area of the first layer 1302. Maintaining the flexibility of the identification tag 1300 at the cryogenic temperature reduces a likelihood of the identification tag 1300 fracturing and separating from the cryogenic storage container due to becoming brittle at the cryogenic temperature. Additionally, maintaining the flexibility of identification tag 1300 minimizes a potential for damage to the cryogenic storage container resulting from contact with the identification tag 1300.

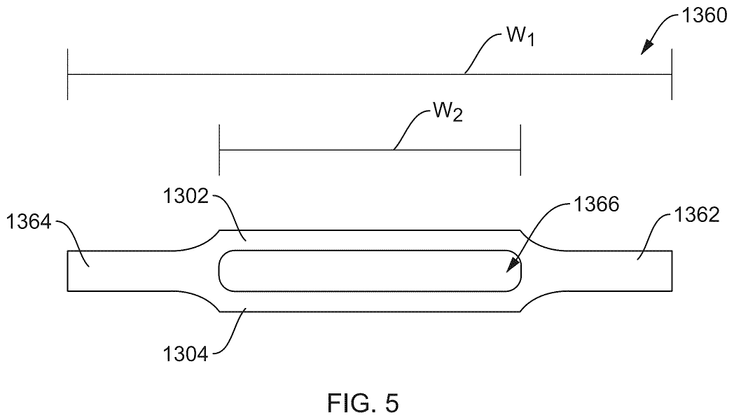

FIG. 5 is a cross-sectional view of the tether portion 1360 taken at x₁-x₁ (FIG. 1). In some embodiments, the sealed region 1310 is configured as a first sealed region 1362 and a second sealed region 1364 in the tether portion 1360. As depicted in FIG. 1, the first sealed region 1362 is separated laterally from the longitudinal axis A_{LO} in a first direction and extends in a longitudinal direction. Similarly, the second sealed region 1364 is separated laterally from the longitudinal axis A_{LO}, except in a second direction that is opposite the first direction. The second sealed region 1364 also extends in the longitudinal direction. In some embodiments, the first sealed region 1362 and the second sealed region 1364 are equidistant from a longitudinal midline (e.g., the longitudinal axis A_{LO}) of the tether portion 1360. The first sealed region 1362 is separated from the second sealed region 1364 by an unsealed region 1366 (e.g., a channel). The first layer 1302 is not joined to the second layer 1304 along the unsealed region 1366. Said another way, the first layer 1302 is movable relative to the second layer 1304 along (e.g., along the longitudinal length) the unsealed region 1366. The movement of the first layer 1302 relative to the second layer 1304 along the unsealed region 1366 facilitates a stiffness of the tether portion 1360 along the unsealed region 1366 is less than a stiffness of each of the first region 1362 and the second sealed region 1364.

Although the unsealed region 1366 is shown as extending to the tip 1345 of the retention portion 1360, in alternative embodiments, the tip 1345 can include an additional sealed portion. In other words, a portion of the first layer 1302 and a portion of the second layer 1304 can be sealed (fused) at the tip 1345. The additional sealed portion at tip 1345 can provide increased strength to the identification tag 1300 for insertion into the retention opening 1322.

In some embodiments, the unsealed region 1366 has a lateral width W₂ that is in the range of 20 to 50 percent of a width W₁ of the tether portion 1360. Maintaining an absence of coupling between the first layer 1302 and the second layer 1304 throughout the unsealed region 1366, establishes a flexibility of the tether portion 1360 at a magnitude that is between the magnitude of the flexibility of the first layer 1302 and the magnitude of the flexibility of the first sealed region 1362 and/or the second sealed region 1364. In other words, the unsealed region 1366 maintains the flexibility of the tether portion 1360 at cryogenic temperatures at a magnitude that is less than would otherwise be achieved if the sealed region 1310 extended across the width W₁ of the tether portion 1360. The increase in the flexibility resulting from the inclusion of the unsealed region 1366 facilitates the establishment and maintenance of the tether portion 1360 in the loop configuration without fracturing even at cryogenic temperatures. The ratio of the lateral width W₂ of the unsealed region 1366 relative to the width W₁ of the tether portion 1360 can be tailored to maintain a desired degree of flexibility of the tether portion 1360 at cryogenic temperatures and also a desired degree of rigidity of the tether portion 1360 at room temperatures.

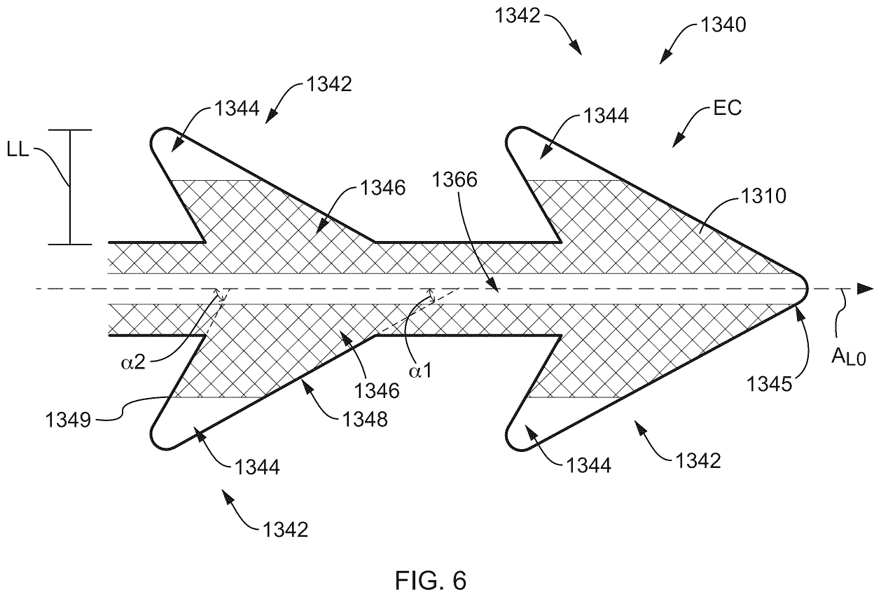

As depicted, in FIG. 6, in some embodiments the retention portion 1340 includes at least one protrusion 1342, which can be a barb shaped to facilitate passage through an opening (e.g., the retention opening 1322) in one direction while resisting passage in the opposite direction. Accordingly, in some embodiments, the protrusion 1342 extends radially outward from the longitudinal axis to a lateral position that is in a range of 0.9 to 1.5 times the width W₁ of the tether portion 1360.

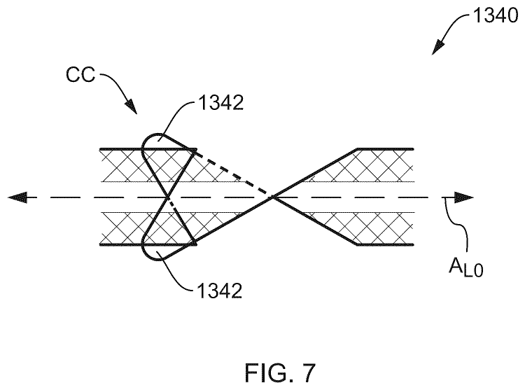

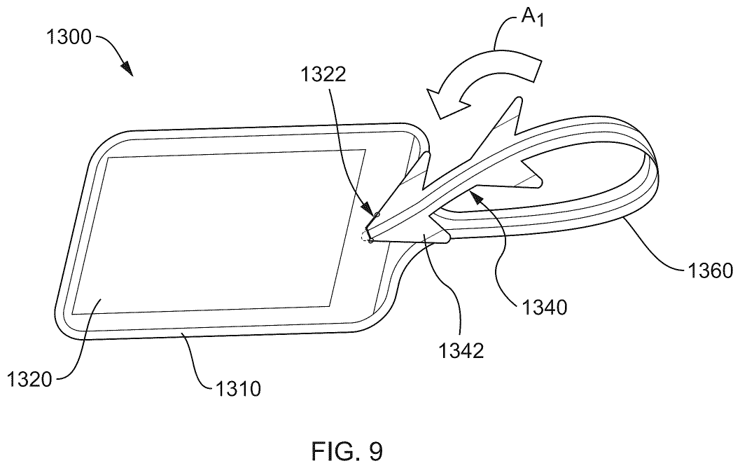

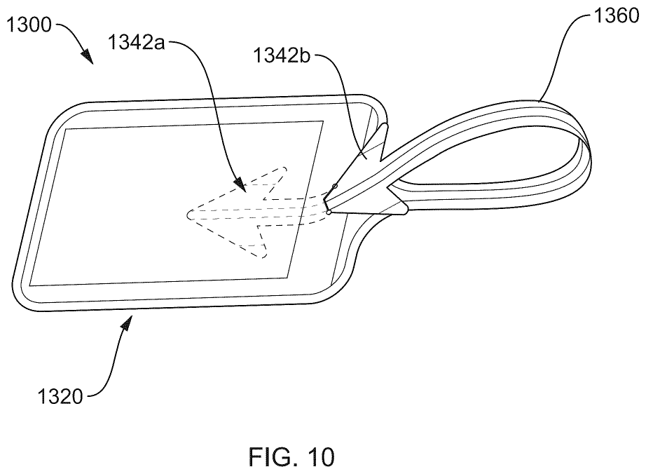

In some embodiments, the protrusion 1342 is deformable (e.g., foldable) between an expanded configuration EC (as depicted in FIGS. 1-4, 6, and 9-13) and a collapsed (e.g., at least partially folded) configuration CC (as depicted in FIG. 7). The protrusion 1342 is in the expanded configuration EC on both the condition that the identification tag 1300 is in the first configuration C₁ and in the second configuration C₂. The protrusion 1342 is in the collapsed configuration CC during a transition of the identification tag 1300 from the first configuration C₁ to the second configuration C₂. In other words, as the retention portion 1340 is threaded through the retention opening 1322, as depicted in FIG. 9, the protrusion 1342 is deformed in order to pass through the retention opening 1322. After passing through the retention opening 1322, the protrusion 1342 returns to the expanded configuration EC, as depicted, for example, in FIGS. 10-13.

In some embodiments, the first layer 1302 and the second layer 1304 can be shaped such that the protrusion 1342 is a barb. In such embodiments, the sealed region 1310 extends partially within the barb 1342. Like the tether portion 1360, the retention portion 1340 can include a first unsealed region between the first layer 1302 and the second layer 1304 that extends along the longitudinal axis A_{LO}. A second unsealed region in which the first layer 1302 is not joined to the second layer 1304 is also formed at a tip 1344 of the barb 1342. As depicted in FIG. 6, the second unsealed region at the tip 1344 of the barb 1342 is separated from the first unsealed region along the longitudinal axis A_{LO} by the sealed region 1310. It should be appreciated that forming the tip 1344 as a second unsealed limits the rigidity of the tip 1344 to that of the first layer 1302 and/or the second layer 1304. In contrast, a sealed region 1310 extending to the tip 1344 would increase the rigidity of the barb 1344 such that the barb 1342 could damage the cryogenic storage container and/or the identification tag 1300.

As depicted in FIG. 6, in some embodiments, the barb 1342 is one of a set of barbs of the retention portion 1340. Each barb 1342 has a span LL (e.g., a lateral length) that extends between a base 1346 and the tip 1344 of the barb 1342. The first layer 1302 and the second layer 1304 are sealed from the base 1346 in the direction of the tip 1344. The portion of the span LL over which the first layer 1302 is sealed to the second layer 1304 can vary. For example, in some embodiments, the portion of the span LL over which the first layer 1302 is sealed to the second layer 1304 can extend between 30 and 75 percent of the span LL. The remainder of the span LL has an absence of sealing (e.g., fusing) between the first layer 1302 and the second layer 1304. In other words, the first layer 1302 and a second layer 1304 can each move independently of the other at unsealed portion at the tip 1344.

Although identification tag 1300 is illustrated with each barb 1342 of the retention portion 1340 as having specific sealed and unsealed portions, it should be understood that an identification tag as described herein can include variations in the sealed and unsealed portions of the retention portion 1340. For example, in some embodiments, the unsealed portion of the span LL of the barbs 1342 can be in the range of 5 percent to 75 percent of the span LL, 5 percent to 50 percent of the span LL, 10 percent to 40 percent of the span LL, 10 percent to 25 percent of the span LL, or 15 percent to 20 percent of the span LL. In some embodiments, the span LL has no unsealed portions. In other words, the first layer 1302 and the second layer 1304 are sealed across the entire span LL of the tips 1344 of the barbs 1342. In some embodiments, one of the barbs 1342 can have unsealed portions across the span LL and the other barb 1342 may not have an unsealed portion. In some embodiments, only one of the spans LL for a given barb 1342 may have an unsealed portion within the span LL and the other span LL of the barb 1342 may have no sealed portion within the span LL. Thus, the barbs 1342 can have various combinations of sealed and unsealed portions in the span LL between the base 1346 and tip 1344 of the barbs 1342.

In some embodiments, each barb 1342 has a leading edge 1348 that extends between the base 1346 and the tip 1344. The leading-edge 1348 intersects the longitudinal axis A_{LO} at a first acute angle α1. The first acute angle α1 facilitates passage of the barb 1342 through the retention opening 1322 during a transition of the identification tag 1300 from the first configuration C₁ to the second configuration C₂. Each barb 1342 also has a trailing edge 1349. The trailing edge 1349 extends between the base 1346 and the tip 1344. The trailing edge intersects the longitudinal axis at a second acute angle α2. The second acute angle α2 is greater than the first acute angle α1. The second acute angle α1 limits the removal of the retention portion 1340 from the retention opening 1322. In some embodiments, the trailing edge 1349 is positioned between the leading edge 1348 and the label opening 1324 on the condition that the identification tag 1300 is in the first configuration C₁. Additionally, the trailing edge 1349 of at least one barb 1342 of the set of barbs is positioned to contact the identification portion 1320 on the condition that the identification tag 1300 is in the second configuration C₂. The contact between the trailing edge 1349 and the second layer 1304 precludes a transition of the identification tag 1300 from the second configuration C₂ to the first configuration C₁. Said another way, the contacting the trailing edge 1349 in the second layer 1304 maintains the tether portion 1360 in the loop configuration and, thereby, maintains the coupling between the identification tag 1300 and the cryogenic storage container.

Referring again to FIG. 8, in some embodiments, the label opening 1324 is positioned at a longitudinal position that is between the retention opening 1322 and the tether portion 1360. As depicted, the retention opening 1322 extends between a pair of stress-distribution holes 1328. The width W₁ of the tether portion is substantially equal to a lateral distance LD between a center point of each of the stress-distribution holes 1328. The positioning of the stress-distribution holes 1328 mitigates a stress concentration that would otherwise result from the passage of the retention portion 1340 and such or the tether portion 1360 through the retention opening 1322. In some embodiments, the retention opening 1322 is, as depicted in FIG. 8, formed as a nonlinear opening. Accordingly, the positioning of the stress-distribution holes 1328 can facilitate the deformation/or displacement of the nonlinear opening to facilitate passage and/or retention of the retention portion 1340.

In some embodiments, the identification portion 1320 includes a third layer 1326. The third layer 1326 is coupled to the first layer 1302 opposite the second layer 1304. A separation between the third layer 1326 and the first layer 1302 defines the label opening 1324. Accordingly, the third layer 1326 and the first layer 1302 form a pocket for receiving and retaining the label 1301. In order to secure the label 1301 within the pocket, each of the first layer 1302, the second layer 1304, and the third layer 1326 define the retention opening 1322. In other words, the retention opening 1322 extends completely through a thickness IP_{T} of the identification portion 1320. Because the retention opening 1322 extends completely through the thickness IP_{T} of the identification portion 1320, the label 1301 is retained when the identification tag 1300 is in the second configuration C₂. In some embodiments, the third layer 1326 includes an indicia (not shown) to visually indicate the passage of the retention portion 1340 through the retention opening 1322 defined by the third layer 1326 thereby occluding the label opening 1324.

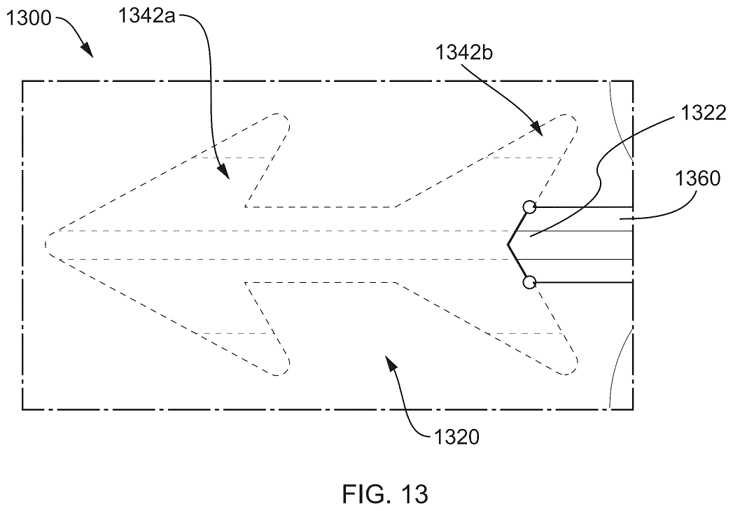

The FIGS. 9-13 depict the transition of the identification tag 1300 to the second configuration C₂. To transition the identification tag 1300 from the first configuration, the retention portion 1340 is moved along the arrow A1 to establish the tether portion 1360 in a loop configuration. FIG. 9 depicts an initiation of the passage of the retention portion 1340 through the retention opening 1322. FIGS. 10-12 depict a mid-transition state of the identification tag 1300. In FIGS. 10-12, a first pair of barbs 1342a has been threaded through the retention opening 1322 while a second pair of barbs 1342b has not been threaded through the retention opening 1322. Accordingly, the first pair of barbs 1342a is separated from the second pair of barbs 1342b by the identification portion 1320. FIG. 13 depicts the identification tag 1300 in the second configuration C₂ with both the first pair of barbs 1342a and the second pair of barbs 1342b having been threaded through the retention opening 1322, returned to the expanded configuration EC, and positioned in contact with the second layer 1304.

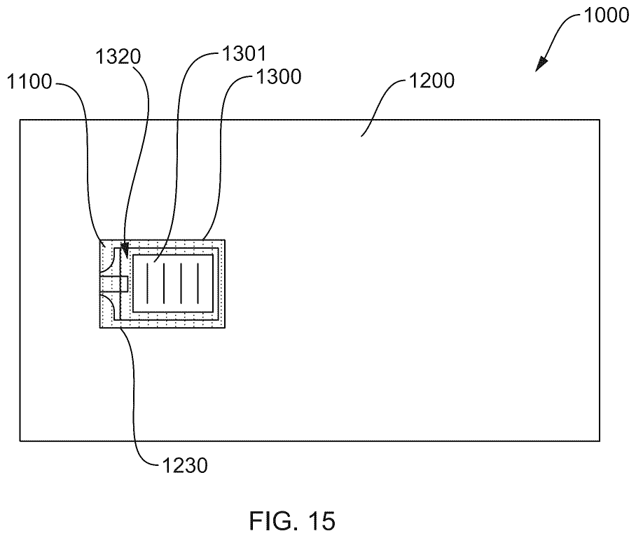

The identification tag 1300 can, in some embodiments, be used with a biological material storage system 1000, such as depicted in FIGS. 14 and 15. The biological material storage system 1000 can include a sample container 1100. The sample container 1100 can include a first flexible layer 1110 and a second flexible layer 1120. The first flexible layer 1110 can be coupled to the second flexible layer 1120 via a set of seals 1130 to define a storage volume 1140. The first flexible layer 1110 and the second flexible layer 1120 are flexible at a cryogenic temperature. Accordingly, the sample container 1100 can be a cryogenic storage bag. Accordingly, the first flexible layer 1110 and the second flexible layer 1120 can be formed from any of the polymers described herein.

The biological material storage system 1000 can also include a cryogenic cassette 1200. The cryogenic cassette 1200 can be sized to receive (as indicated by arrow B1) the sample container 1100. The cryogenic cassette 1200 can include a body portion 1210 and a cover 1220. At least one of the body portion 1210 or the cover 1220 can define an observation aperture 1230. The cryogenic cassette 1200 can support the sample container 1100, but the sample container 1100 is in fluid contact with an environment surrounded cryogenic cassette 1200 on a condition that the sample container 1100 is positioned within the cryogenic cassette 1200.

As a component of the biological material storage system 1000, the identification tag 1300 can be movably coupled to the sample container 1100 via the tether portion 1360 is described herein. The identification tag 1300 is positioned within the cryogenic cassette 1200 along with the sample container 1100. Accordingly, the identification tag 1300 is configured to be moved along the direction indicated by arrow B2 such that the identification portion 1320 of the identification tag 1300 is aligned with the observation aperture 1230 on the condition that the sample container 1100 is positioned within the cryogenic cassette 1200. Being aligned with the observation aperture 1230 as depicted in FIG. 15, the label 1301 can display crucial information about the sample without necessitating the removal of the sample container 1100 from the cryogenic cassette 1200 nor even the opening of the cryogenic cassette 1200. By facilitating the gathering of information about the cryogenic storage sample without requiring handling of the sample container 1100, the likelihood of damaging the sample container 1100 is, therefore, reduced and/or eliminated.

In some embodiments, a method of providing an identification tag to an item for cryogenic storage is provided. The identification tag can include components and functions as described herein. For example, the identification tag can include an identification portion, a retention portion and a tether portion as described herein. The identification portion can define a retention opening and a label opening, and the label opening can be sized to receive a label therein. The retention portion can be sized to be received by the retention opening. The tether portion can extend between the identification portion and the retention portion and define a longitudinal axis of the identification tag in a first configuration. The method includes when the identification tag is in the first configuration, the retention portion of the identification tag is placed through a portion of the item for cryogenic storage. The retention portion of the identification tag is then pushed through the retention opening to retain the identification tag to the item for cryogenic storage. The method can further optionally include placing a label associated with the item for cryogenic storage within the label opening. In some embodiments, the retention portion includes a barb, and the pushing the retention portion through the retention opening includes pushing the barb through the retention opening.

While the discussion herein has been directed to the introduction of biological material into the container assembly, it is appreciated that other materials could be introduced in the various packaging as well. For example, any of the containers or container assemblies described can store pharmaceutical ingredients (including active pharmaceutical ingredients, dilutents, preservatives, inert components, or other pharmaceutical ingredients). Such pharmaceutical ingredients can be packaged and stored in any of the containers or container assemblies described herein for storage, distribution, and later compounding, mixing, or other pre-delivery preparation steps.

In accordance with various embodiments, each of the containers within the various container assemblies can include passages that extend between the various container volumes. In this way, liquid, paste, gelatounous or similar materials could flow between one or more of the connected volumes as a single volume is filled. Once filled, one or more seals could be used to seal each of the volumes.

While some embodiments have been described above, it should be understood that they have been presented by way of example only, and not limitation. Where methods and/or schematics described above indicate certain events and/or flow patterns occurring in certain order, the ordering of certain events and/or operations may be modified. While the embodiments have been particularly shown and described, it will be understood that various changes in form and details may be made.

Although some embodiments have been described as having particular features and/or combinations of components, other embodiments are possible having a combination of any features and/or components from any of embodiments as discussed above. Aspects have been described in the general context of medical devices, and more specifically tissue packaging devices, but inventive aspects are not necessarily limited to use in medical devices and tissue packaging.

1. An identification tag for cryogenic storage, the identification tag comprising:
an identification portion defining a retention opening and a label opening, the label opening being sized to receive a label on a condition that the identification tag is in a first configuration;
a retention portion sized to be received by the retention opening to at least partially occlude the label opening on a condition that the identification tag is in a second configuration in which the label is received by the identification portion and the identification tag is coupled to a cryogenic storage container; and
a tether portion extending between the identification portion and the retention portion, the tether portion defining a longitudinal axis of the identification tag in the first configuration.

2-3. (canceled)

4. The identification tag of claim 1, wherein:
the identification portion, the tether portion and the retention portion are formed from a first layer coupled to a separate second layer via at least one sealed region; and
an area of the sealed region is in a range of 2 to 15 percent of an area of the first layer.

5. (canceled)

6. The identification tag of claim 4, wherein:
the sealed region in the tether portion is a first sealed region that is separated laterally from the longitudinal axis in a first direction and extends in a longitudinal direction;
the tether portion includes a second sealed region that is separated laterally from the longitudinal axis in a second direction opposite the first direction and extends in the longitudinal direction; and
the first sealed region is separated from the second sealed region by an unsealed region in which the first layer is not joined to the second layer.

7. The identification tag of claim 6, wherein:
the first layer is movable relative to the second layer along the unsealed region; and
the movement of the first layer relative to second layer along the unsealed region facilitates a stiffness of the tether portion along the unsealed region that is less than a stiffness of each of the first sealed region and the second sealed region.

8. The identification tag of claim 6, wherein:
the tether portion is flexible at cryogenic temperatures.

9. The identification tag of claim 6, wherein:
the unsealed region has a lateral width that is in the range of 20 to 50 percent of a width of the tether portion.

10. The identification tag of claim 6, wherein:
the first layer and the second layer are shaped to form a barb of the retention portion;
the sealed region extends partially within the barb;
the unsealed region is a first unsealed region;
a second unsealed region in which the first layer is not joined to the second layer is formed at a tip of the barb; and
the second unsealed region is separated from the first unsealed region by the sealed region.

11. The identification tag of claim 10, wherein:
the identification portion includes a third layer coupled to the first layer opposite the second layer;
a separation between the third layer and the first layer defining the label opening;
each of the first layer, the second layer, and the third layer defining the retention opening such that the retention opening extends completely through a thickness of the identification portion;
the barb has an expanded configuration on the condition that the identification tag is in the first configuration and on the condition that the identification tag is in the second configuration;
the barb is precluded from passing through the retention opening in the expanded configuration;
the barb has a collapsed configuration during a transition of the identification tag from the first configuration to the second configuration; and
the collapsed configuration facilitates passage of the retention portion through the retention opening.

12. (canceled)

13. The identification tag of claim 1, wherein:
the retention opening extends between a pair of stress-distribution holes; and
a width of the tether portion is substantially equal to a lateral distance between a center point of each of the stress-distribution holes.

14. (canceled)

15. The identification tag of claim 13, wherein:
the retention portion includes a protrusion that extends radially outward from the longitudinal axis to a lateral position that is in a range of 0.9 to 1.5 times the width of the tether portion;
the protrusion is deformable between an expanded configuration and a collapsed configuration;
the protrusion is in the expanded configuration on the condition that the identification tag is in the first configuration and on the condition that the identification tag is in the second configuration; and
the protrusion is in the collapsed configuration during a transition of the identification tag from the first configuration to the second configuration.

16. The identification tag of claim 1, wherein:
the retention portion includes a plurality of barbs formed by a first layer and a separate second layer;
each barb of the plurality of barbs has a span between a base and a tip;
the base of each barb of the plurality of barbs is positioned laterally between the tip and the longitudinal axis; and
the first layer and the second layer are sealed from the base in the direction of the tip along between 30 and 75 percent of the span of each barb of the plurality of barbs and have an absence of sealing along a remainder of the span to the tip.

17. (canceled)

18. The identification tag of claim 1, wherein:
the tether portion is coupled to the identification portion via a transition portion;
the transition portion includes a pair of concave radii bisected by the longitudinal axis; and
the concave radii are sized to mitigate a stress concentration resulting from a greater width of the identification portion relative to a width of the tether portion.

19. The identification tag of claim 1, wherein:
the cryogenic storage container is a cryogenic storage bag configured to store biological material; and
the tether portion is threaded through a portion of the cryogenic storage bag on the condition that the identification tag is in the second configuration.

20. The identification tag of claim 19, wherein:
the cryogenic storage bag and the identification tag are each formed from fluorinated ethylene propylene and are flexible at a cryogenic temperature.

21. A biological material storage system comprising:
a sample container including a first flexible layer coupled to a second flexible layer via a plurality of seals to define a storage volume, the first flexible layer and the second flexible layer being flexible at a cryogenic temperature;
a cryogenic cassette sized to receive the sample container, the cryogenic cassette including a body portion and a cover, at least one of the body portion or the cover defining an observation aperture, the sample container being in fluid contact with an environment surrounding the cryogenic cassette on a condition that the sample container is positioned within the cryogenic cassette; and
an identification tag movably coupled to the sample container via a tether portion of the identification tag, the identification tag being positioned within the cryogenic cassette on the condition that the sample container is positioned within the cryogenic cassette, an identification portion of the identification tag being aligned with the observation aperture on the condition that the sample container is positioned within the cryogenic cassette.

22. The biological material storage system of claim 21, wherein:
the first flexible layer, the second flexible layer, and the identification tag are each formed from fluorinated ethylene propylene and are flexible at the cryogenic temperature.

23. The biological material storage system of claim 21, wherein:
the identification portion of the identification tag defines a retention opening and a label opening;
the label opening is sized to receive a label prior to the identification tag being movably coupled to the sample container;
the identification tag includes a retention portion that is received by the retention opening to at least partially occlude the label opening and movably couple the identification tag to the sample container;
the tether portion extends between the identification portion and the retention portion; and
the tether portion defines a longitudinal axis of the identification tag prior to the identification tag being movably coupled to the sample container.

24. The biological material storage system of claim 21, wherein:
the identification portion, the tether portion and a retention portion are formed from a first layer coupled to a separate second layer via at least one sealed region; and
an area of the sealed region is in a range of 2 to 15 percent of an area of the first layer.

25. (canceled)

26. The biological material storage system of claim 24, wherein:
the sealed region in the tether portion is a first sealed region that is separated laterally from a longitudinal axis in a first direction and extends in a longitudinal direction;
the tether portion includes a second sealed region that is separated laterally from the longitudinal axis in a second direction opposite the first direction and extends in the longitudinal direction;
the first layer and the second layer define an unsealed region extending along the longitudinal axis between the first sealed region and the second sealed region; and
the first layer is decoupled from the second layer along the unsealed region.

27. (canceled)

28. The biological material storage system of claim 26, wherein:
the unsealed region has a lateral width that is in the range of 20 to 50 percent of a width of the tether portion.

29. The biological material storage system of claim 24, wherein:
the first layer and the second layer are shaped to form a plurality of barbs of the retention portion;
the sealed region extends partially within each barb of the plurality of barbs;
the first layer has an absence of fusing with the second layer at a tip of each barb of the plurality of barbs; and
each barb of the plurality of barbs has a lateral length that is in a range of 75 to 110 percent of a width of the tether portion.

30. The biological material storage system of claim 29, wherein:
the identification portion includes a third layer coupled to the first layer opposite the second layer;
a separation between the third layer and the first layer defining a label opening;
each of the first layer, the second layer, and the third layer defining a retention opening such that the retention opening extends completely through a thickness of the identification portion;
each barb of the plurality of barbs has an expanded configuration prior to the identification tag being movably coupled to the sample container and when movably coupled to the sample container;
each barb of the plurality of barbs is precluded from passing through the retention opening in the expanded configuration; and
each barb of the plurality of barbs has a collapsed configuration during a passage of each barb of the plurality of barbs through the retention opening.

31. A method of providing an identification tag to an item for cryogenic storage, the identification tag including an identification portion, a retention portion and a tether portion, the identification portion defining a retention opening and a label opening, the label opening being sized to receive a label therein, the retention portion being sized to be received within the retention opening, the tether portion extending between the identification portion and the retention portion, the tether portion defining a longitudinal axis of the identification tag when the identification is in a first configuration, the method comprising:
when the identification tag is in the first configuration, placing the retention portion of the identification tag through a portion of the item for cryogenic storage; and
pushing the retention portion through the retention opening to retain the identification tag to the item for cryogenic storage.

32. The method of claim 31, further comprising:
placing a label associated with the item for cryogenic storage within the label opening.

33. The method of claim 31, wherein the retention portion includes a barb, the pushing the retention portion through the retention opening includes pushing the barb through the retention opening.
